(19) United States
(12) Patent Application Publication
(10) Pub. No.: US 2014/0256338 A1
(43) Pub. Date: Sep. 11, 2014

(54) METHOD AND DEVICE FOR CELLULAR COMMUNICATIONS

(71) Applicant: Samsung Electronics Co., Ltd., Gyeonggi-do (KR)

(72) Inventors: Lixiang Xu, Beijing (CN); Chengjun Sun, Beijing (CN)

(73) Assignee: Samsung Electronics Co., Ltd., Gyeonggi-do (KR)

(21) Appl. No.: 14/353,915

(22) PCT Filed: Oct. 24, 2012
(86) PCT No.: PCT/KR2012/008742

§ 371 Date: Apr. 24, 2014

(30) Foreign Application Priority Data
Oct. 24, 2011 (CN) 201110324871.5

(51) Int. Cl. H04W 72/04

(52) U.S. Cl. CPC H04W 72/04
USPC 455/450

(57) ABSTRACT

The embodiments of the present invention provide a method for cellular communications, comprising the following steps: network side equipment receiving service request of user equipment (UE); network side equipment selecting communications resource of two or more base stations for the UE; the base station communicating with the UE. The present invention also provides network side equipment and user equipment (UE). The mobile communication system can simultaneously serve UE by providing multiple base stations and/or base station having various communication modes by means of the scheme set forth in the present invention. In addition, regardless of the network side equipment and UE, they can dynamically load adapted access technology, so that the user can access to different communication systems anytime and anywhere, and meanwhile the system can dynamically and adaptively be adjusted, according to the existing resource of the network, to providing service of wider bandwidth, higher rate for users.

### TECHNICAL FIELD

The present invention relates to mobile communications technology, and in particular, to a method and a device for cellular communications.

### BACKGROUND ART

Modern mobile communications increasingly tend to provide omnibearing multimedia service for users, and the third generation mobile communications and evolution technology thereof have become the main research field of modern mobile communications. For example, FIG. 1 is a system architecture diagram of SAE (System Architecture Evolution), wherein UE (User Equipment) 101 is terminal equipment for receiving data. E-UTRAN (Evolution-Universal Terrestrial Radio Access Network) 102 is a wireless access network, including a macro base station eNB that provides access to a wireless network interface for UE. MME (Mobile Management Entity) 103 is responsible for managing mobile context, session context and security information of UE. SGW (Service Gateway) 104 mainly provides functions of user plane, and MME 103 and SGW 104 may be in an identical physical entity. PGW (Packet Data Network Gateway) 105 is responsible for functions such as charging and lawful interception, which may be in an identical physical entity with SGW 104. PCRF (Policy and Charging Rules Function) 106 provides QoS (Quality of Service) policies and charging criteria. SGSN (Serving GPRS Support Node) 108 is network node equipment that provides a route for transmission of data in a UMTS (Universal Mobile Telecommunications System). HSS (Home Subscriber Server) 109 is a home subsystem of UE and is responsible for protecting user information including the current location of user equipment, the address of service nodes, user security information, packet data context of user equipment.

The architecture of E-UTRAN supporting Relay or RN (Relay Node) is shown as FIG. 2, wherein the macro base station eNB and RN are included. RN accesses to DeNB (an eNB serving the relay) via a modified E-UTRAN wireless interface Un. RN is the termination of E-UTRAN air interface and S1/X2 interface. RN does not support NNSF (NAS Node Selection Function). DeNB also provides functions similar to S-GW/P-GW for the operation of RN. DeNB terminates S11 interface between MME and it.

Currently, RN can only be connected access to a core network by one DeNB, but and does not support NNSF. In a city dense region, one RN may serve many UEs, and as since UE's demands for the more and more kinds of service become more and more, the traffic volume is larger and larger, and the rate of service traffic is higher and higher. How to satisfy user's these requirements of users is a very important problem issue. If RN is used in a mobile environment such as bus, subway or high-speed rail, the number quantity and kinds type of base stations are all fewer along the metro lines. In this case, how to satisfy users' demands within the coverage range of RN is also a problem in need of special attention. In addition, generally the access modes of UE in a RN service region are generally different, how to simultaneously serve terminals having different access modes is also a problem which requires solution. Without considering RN, network also faces the same problem, that is, how to provide service satisfying QoS for increasing users' demands.

Therefore, it is necessary to set forth more advanced access technology and communications network architecture so as to solve the problem that it is inconvenient for users to access to networks in the prior art.

### DISCLOSURE OF INVENTION

### Technical Problem

The objective of the present invention is to solve at least one of the above defects, and in particular, to simultaneously serve UE by providing a plurality of base stations and/or a base station having various communications modes, and network side equipment and UE can dynamically load adapted access technology, such that users are accessible to different mobile communications systems anytime in any place.

### Solution to Problem

To achieve the objective of the present invention, the present invention in one aspect provides a method for cellular communications, comprising the following steps:

network side equipment receiving service request of user equipment (UE);

network side equipment selecting communications resource of two or more base stations for the UE;

the base station communicating with the UE.

The present invention in another aspect further provides network side equipment, comprising:

a receiving module for receiving service request and data information of user equipment;

a resource allocation module for selecting communications resource of two or more base stations for the UE; and

a sending module for sending data information to the UE.

The present invention in another aspect also provides a method for cellular communications, comprising the following steps:

user equipment (UE) sending service request to network side equipment;

the UE receiving communications resource of two or more base stations that the network side equipment selects for the UE on a common channel;

the UE communicating with the base stations.

The present invention in another aspect further provides user equipment, comprising:

a sending module for sending service request to network side equipment;

a receiving module for receiving communications resource of two or more base stations selected by the network side equipment; and

a resource allocation module for allocating corresponding resource for the service; and

the sending module and the receiving module communicate with the network side equipment.

### Advantageous Effects of Invention

By means of the above scheme set forth in the present invention, the mobile communications system can simultaneously serve UE by providing a plurality of base stations and/or a base station having various communications modes. In addition, both network side equipment and UE can dynamically load adapted access technology such that users can access to different mobile communications systems anytime in any place, and meanwhile the system can be dynamically and adaptively adjusted to providing service with broader bandwidth and higher rate to users according to the existing resource of network. The above methods or equipments set forth in the present invention only have little change to the existing equipments and systems so that the compatibility of equipments will not be influenced, and simpleness and efficiency are achieved.

Some of the additional aspects and advantages of the present invention will be presented in the following description, and some will become obvious in the following description, or known by carrying out the present invention.

### BRIEF DESCRIPTION OF DRAWINGS

The above and/or additional aspects and advantages of the present invention will be more obvious and easily understood through the following description of the embodiments in combination with drawings, wherein:

FIG. 1 is a schematic diagram of the structure of the existing SAE system.

FIG. 2 is an architecture diagram of E-UTRAN supporting RN.

FIG. 3 is Embodiment 1 of the present invention.

FIG. 4 is a schematic diagram of data merge.

FIG. 5 is Embodiment 2 of the present invention.

FIG. 6 is information transmission of air interfaces in a communications system.

FIG. 7 is Embodiment 3 of the present invention;

FIG. 8 is Embodiment 4 of the present invention;

FIG. 9 is Embodiment 5 of the present invention;

FIG. 10 is Embodiment 6 of the present invention;

FIG. 11 is Embodiment 7 of the present invention.

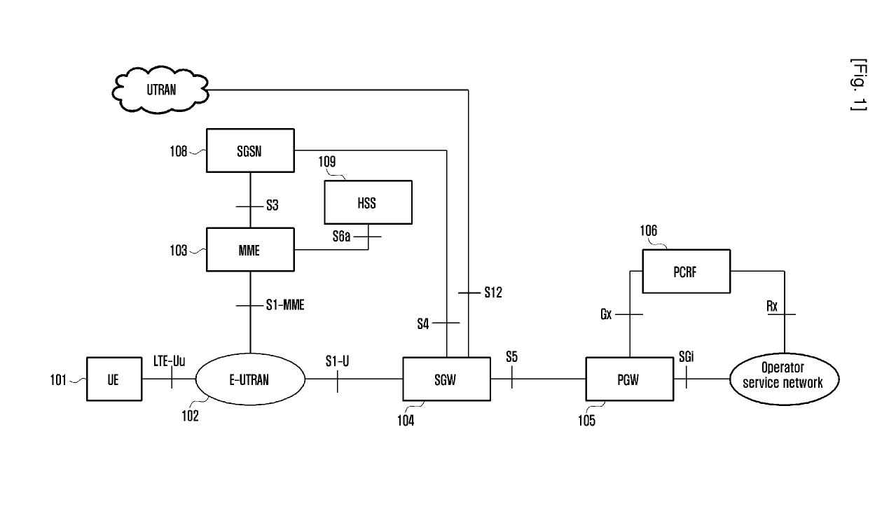

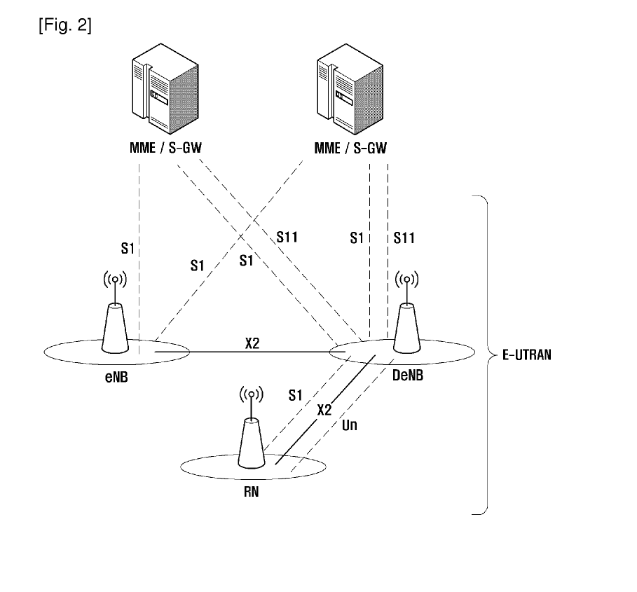

### MODE FOR THE INVENTION

The embodiments of the present invention are specifically described as follows, and the examples of the embodiments are illustrated in the drawings, wherein the same or similar signs represent the same or similar elements or elements having the same or similar functions all the way. The following embodiments described by reference drawings are exemplary and are only used to explain the present invention and cannot be construed as limiting the present invention.

Generally, different communications modes correspond to different access technologies, that is, different communications systems have different access technologies and access modes. Service can be obtained in a communications system only by using corresponding technology to access to a communications system with a matching communications mode. To achieve the objective of the present invention, the embodiment of the present invention provides a method for cellular communications, comprising the following steps:

network side equipment receiving service request of user equipment (UE);

network side equipment selecting communications resource of two or more base stations for the UE according to the service request, wherein at least two base stations have different communications modes;

the base station communicating with the UE based on the communications resource.

According to the above method set forth in the present invention, network side equipment can simultaneously serve UE by providing a plurality of base stations or a base station having various communications modes. In the present invention, network side equipment includes, but is not limited to RN, base station or resource management module functional entity.

For example, when the network side equipment is RN, RN obtains available resource information according to cell broadcasting of the base station or broadcasting information of the resource management module, or through communication with a management module of the base station. RN also establishes uplink and downlink user plane information with the base station, builds carriers for data transmission and selects the communications resource of two or more base stations for UE.

When the network side equipment is a resource management module functional entity, the resource management module functional entity communicates with the base station to update resource state information, so as to select communications resource of two or more base stations for UE.

When the resource management module function entity performs resource allocation, if there is RN in the base station, it is also included that end-to-end communication is established between RN and the resource management module functional entity to select communications resource of two or more base stations for UE.

In the present invention, the base station includes but is not limited to the following base stations with one or more communications modes: GSM base station, WCDMA base station, LTE base station or LTE-A base station.

In addition, a base station or RN in the base station, according to service request of UE or environmental condition, dynamically adds the supported access modes, wherein the communications modes corresponding to the access modes include but are not limited to the following one or more communications modes: GSM, WCDMA, LTE or LTE-A.

To enable user equipments using different modes to access to network of different modes, as the embodiments of the present invention, uplink and downlink common channels independent from communications modes are established between network side equipment and UE, by which the network side equipment and UE perform resource information interaction, the uplink and downlink common channels sending common information of various access technologies.

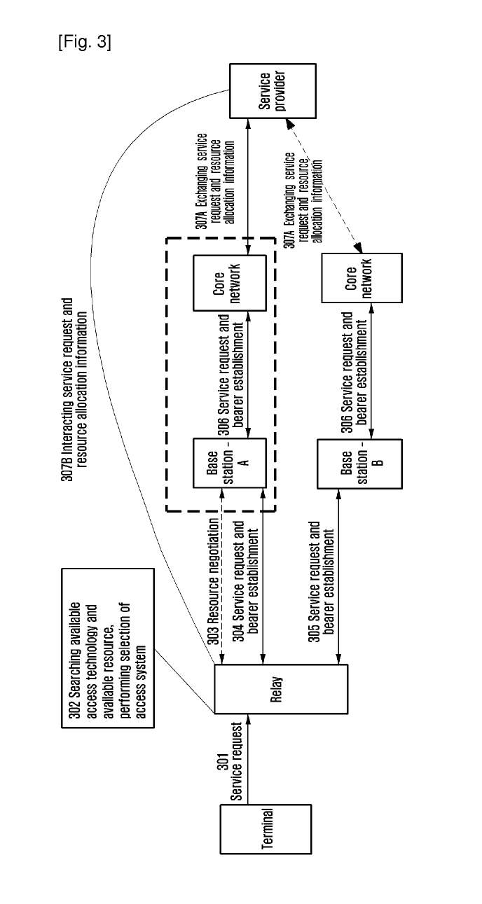

FIG. 3 is Embodiment 1 of the present invention. In this embodiment, the relay can provide service for UE by a plurality of base stations or a base station having various communications modes, and can merge data from a plurality of base stations. As shown in FIG. 3, the flow comprises:

Step 301: the terminal has service request, and sends a service request message to network side equipment, such as to the relay. The message comprises service type of terminal request and QoS information.

Step 302: the relay searches available access technology and available resource according to the service request of the terminal and selects an access system for serving the terminal. There are various specific searching modes, for example,

Mode 1: cells of the respective base stations broadcast available resource information or QoS information that can be provided. The relay obtains available resource information by listening for corresponding information.

Mode 2: a new resource management module functional entity is configured whose function is managing resource information of all access systems in the system. The resource management module functional entity broadcast available resource information. A common module can obtain resource information available for cells of each base station by interacting with each base station.

According to resource information available for each access system, the relay decides which access system(s) are used to serve UE. For example, the service which UE requests requires a bandwidth of 50M, and then the relay can select to provide a bandwidth of 30M for UE at base station A and a bandwidth of 20M for UE at base station B. The base stations A and B can adopt same access technology or different ones, for example, base station A is a WCDMA base station while base station B is an LTE base station.

Step 303: the relay sends information to base station A for negotiating available resource. If base station A can provide the required service, the base station sends an acknowledgement message to the relay. In the method of the present invention, this step is not a necessary step and it is possible to directly jump to step 304.

Step 304: the relay sends a service request message to base station A, and uplink and downlink user plane information is exchanged between the relay and the base station to establish bearer for data transmission (e.g., 30M data transmission). Base station A can allocate downlink user plane transmission resource after receiving the request message from the relay, and then send the request message to a core network to notify the core network of the allocated downlink user plane resource. A response message of the core network is sent to the relay after the response message is received, and the relay is notified of the allocated downlink user plane information.

Step 305, the relay sends a service request message to base station B, and uplink and downlink user plane information is exchanged between the relay and the base station to establish bearer for data transmission (e.g., 20M data transmission). Alternatively, the resource negotiation process in step 303 can be performed with base station B before this step. Base station B can allocate downlink user plane transmission resource after receiving request message from the relay, and then send the request message to the core network to notify the core network of the allocated downlink user plane resource. A response message of the core network is sent to the relay after the response message is received, and the allocated uplink user plane information is notified to the relay.

Step 306, the base station initiates a service request and establishes bearer with the core network. The base station can send a response message of the core network to the relay after receiving the response message, and notify the relay of the allocated uplink user plane information.

The message about the process of establishing user plane between the relay and the core network can also be transferred by the base station, and the base station does not need to analyze specific content of the message. This embodiment only takes an example to explain a method of establishing user plane between the relay and the core network. How to specifically establish is not the emphasis of the present invention, and it can be other specific modes but will not affect the main content of the present invention.

Step 307: a service provider is notified of the information about the service request and resource allocation. There may be various modes to notify the service provider of the information about the service request by UE and about the bearer allocation. For example,

Mode 1: notifying the service provider is notified by the core network of the information allocated by the service request and resource by the core network about the service request and source allocation, wherein the information allocated by resource requires information about the source allocation, for example, network A needs to provide a bandwidth of 30M bandwidth and network B needs to provide a bandwidth of 20M bandwidth. Corresponding to this method, it the relay is requires required to notifying the core network of the relevant information by the relay through the base stations in Step 304, Step 305 and Step 306, wherein the information may include a service identifiers that may be the unique service identifier or names in the whole network, such as IP address and APN information. Let the core network know is made known of the resource allocation of the service of an identical UE in two networks. The identical service is transmitted on two bearers of two networks, for example, the service requested by UE is 50M, wherein 30M is transmitted on base station A while 20M is transmitted on base station B. Such core network can notify the service provider of the relevant information.

Mode 2: the information about the service request and source allocation is directly transmitted to the service provider by the relay. The information includes the information capable of identifying service, and/or the information capable of identifying bearer in each access network, and/or QoS information of service, and/or information about how the service is harmoniously transmitted in multiple bearers.

The modes of notifying the service provider are not enumerated herein. The present invention may use any one of the above modes but is not limited to the above two modes.

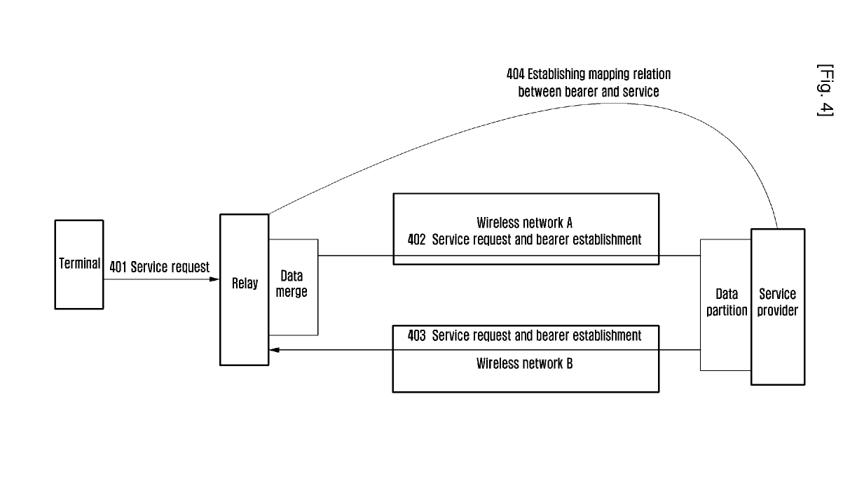

In this case, the service provider can send the data to the relay through two networks respectively. For example, if the size of each packet is 10M, three packets can be sent to base station A by network A, and then two packets are sent to base station B by network B, and again three packets are sent to base station A by network A and two packets are sent to base station B by network B, and so on. Each packet header includes a corresponding serial number. So, after receiving packets from two links, the relay can sequentially sent the packets to the terminal at the air interface in accordance with the serial number. For example, three packets received from base station A are firstly sent, and then two packets received from base station B are sent, and again three packets received from base station A are sent, and so on. The uplink data are also sent in a similar way. FIG. 4 is the schematic diagram. Obviously, the merge and partitioning of data may be also conducted at terminal side.

The method in this embodiment may also be used in network architecture without relay. In this situation, the relay in the drawings and specification is an ordinary terminal which can search available access technology and available resource and then select to which access system(s) are used to provide the required service according to service request. If a plurality of access systems are selected to provide the same service for UE, the method from step 302 to step 307 can be used to serve UE. The method does not include the content of step 301.

Now, the whole work flow in Embodiment 1 of the communications system and communications method of the present invention is completed.

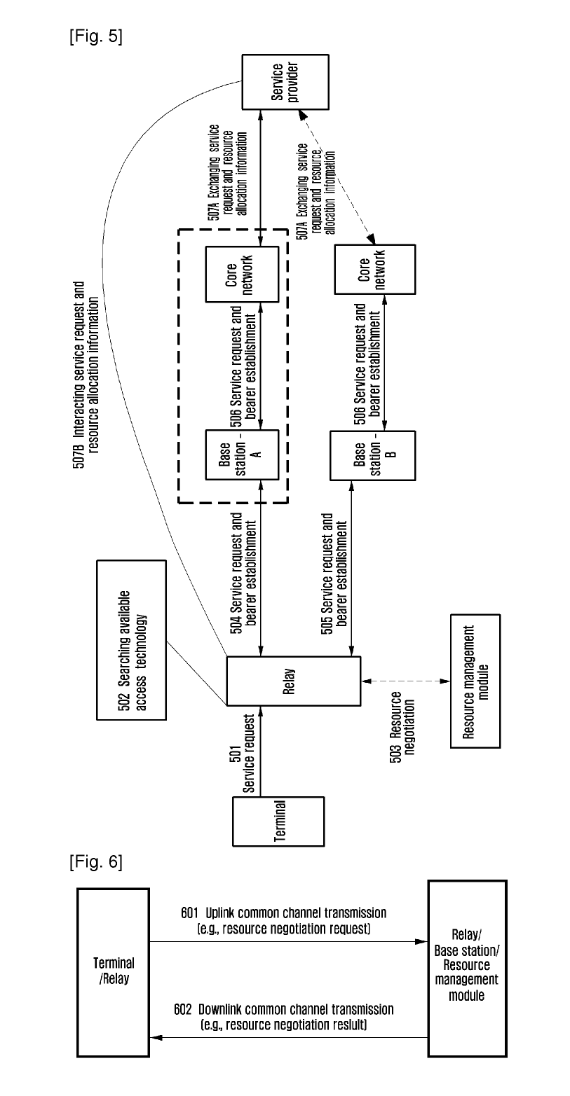

FIG. 5 is Embodiment 2 of the present invention. In this embodiment, the relay can simultaneously provide service for UE by a plurality of base stations or a base station having various communication modes, and can merge data from a plurality of base stations. In this system architecture, there is a new resource management module functional entity. The function of this entity is managing resource information of all access systems in the system. The resource information may be available resource or used resource information in each access system, or resource information of each cell of each access system. This functional entity can communicates with the base station (such as base station A or base station B) to update resource state information. As shown in FIG. 5, the flow comprises:

Step 501 is similar to step 301, thus no more details are presented here.

Step 502: the relay searches available access technology according to service request of the terminal.

Step 503, the relay sends a message to a resource management module to negotiate available resource of the access system. The resource management module can obtain resource information available for cells of each base station by interacting with each base stations. According to resource information available for each access systems, the relay decides which access system(s) are used to serve UE. For example, the service which UE requests requires a bandwidth of is 50M. The relay can select to provide a bandwidth of 30M for UE at base station A and a bandwidth of 20M for UE at base station B. The base station A and base station B may use the same access technology or different ones, for example, base station A is a WCDMA base station while base station B is an LTE base station.

The communications between the relay and the resource management module is end-to-end, for example, it is conducted by any base station at the current location, and the base station transparently transmits the content of the communications therebetween.

Steps 504 to 507 are similar to steps 304 to 307, thus no more details are presented here.

The method in this embodiment may also be used in a condition without relay. In this situation, the relay in the drawings and the specification is an ordinary terminal which can search available access technology and obtain resource available for cells of each access technology at the current location, and then select which access system(s) are used to provide the required service according to service request. If a plurality of access systems are selected to provide an identical service for UE, the method from steps 502 to 507 can be used to provide service for UE. In this case, the method does not include the content of step 501.

Now the whole work flow in Embodiment 2 of the communications system and communications method of the present invention is completed.

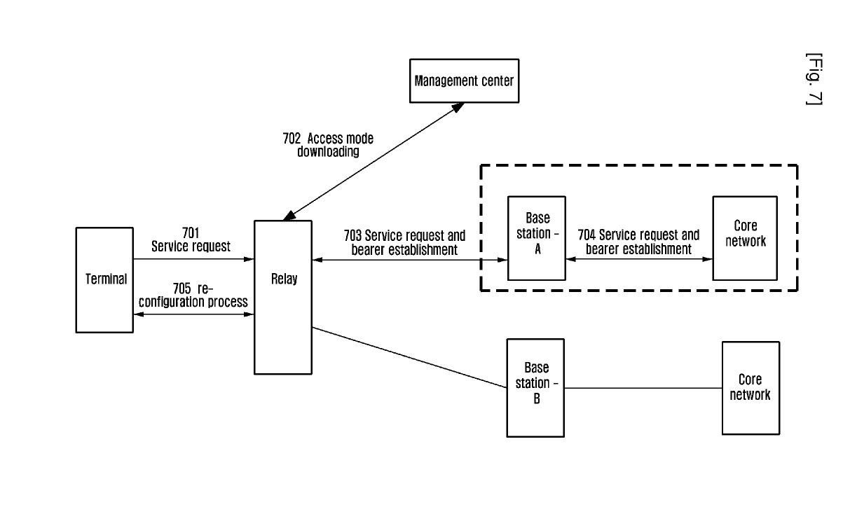

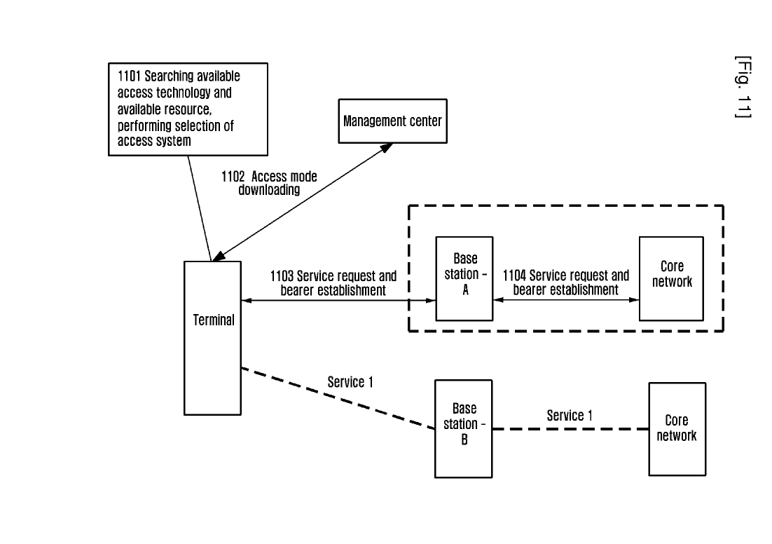

In the present invention, uplink and downlink common channels can be respectively designed between the terminal and the relay, between the relay and the base station, between the terminal and the resource management module, or between the terminal and the base station, wherein the common channel is a new channel independent from the access system, that is, it is the same in all access systems and is used for transmitting common information in heterogeneous networks. The common channel can be achieved in two ways. One is designing a new channel for broadcasting available resource information at the current location. Location field, operator field, access technology field and frequency field are included in this channel. Resource information field corresponding to a certain location, operator and access technology is also contained herein. UE listens to the corresponding broadcasting channel, obtains broadcasting information, and selects how and where to access according to the current location of UE and the resource information that can be provided by the respective operators and access technology. The available resource information at the current location can be known in real time as long as the network and terminal add the common channel functional module. Another way is adding broadcasting information in the existing access system broadcasting information. For example, adding the information in the first way in GSM broadcasting information, and then the GSM system can broadcast available resource of each access technology around. According to available resource information, UE can select how and where to access. According to available resource information, UE can also download new access technology software to add the supported access technology (as illustrated in the embodiment of FIG. 10), and make the best use of available resource. Likewise, the above function can also be achieved by adding broadcasting information in a LTE system. As shown in FIG. 6, the detailed explanation of FIG. 6 is presented in the following text. This new channel may be supported by the existing system, and the new channel transmission mechanism can be supported by adding a new entity in the existing system, so as to enhance the function of the existing system.

Step 601: the terminal transmits the common information of each access system to the relay in the uplink common channel; or the relay transmits the common information of each access system to the base station in the uplink common channel; or the terminal transmits the common information of each access system to the resource management module in the uplink common channel; or the relay transmits the common information of each access system to the resource management module in the uplink common channel; or the terminal transmits the common information of each access system to the base station in the uplink common channel. The information is, for example, resource negotiation request.

Step 602: the relay transmits the common information of each access system to the terminal in the downlink common channel; or the base station transmits the common information of each access system to the relay in the downlink common channel; or the resource management module transmits the common information of each access system to the terminal in the downlink common channel; or the resource management module transmits the common information of each access system to the relay in the downlink common channel; or the base station transmits the common information of each access system to the terminal in the downlink common channel. The information is, for example, a resource negotiation result. The information is, for example, Public Land Mobile Network (PLMN) information available at this location, the information of access system on each PLMN, or available resource information of each cell of each access system, etc.

In the case of not designing a new channel, it is possible to enhance the function of uplink and downlink channels in the existing system so that the existing system can broadcast resource information of adjacent different base stations or base station having different communication modes.

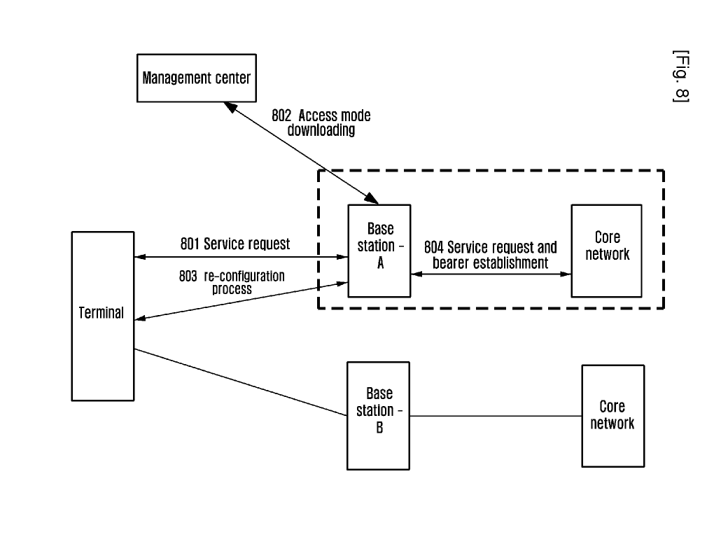

FIG. 7 is Embodiment 3 of the present invention. In this embodiment, the relay can dynamically change the access mode it supports. The relay dynamically adds the supported access mode according to the service request of the UE served or the access mode of the available base station in the environment, and the relay can download the access mode required to be supported from a common management center. The access mode is carried out by different software programming and does not require the support of hardware such as Field Programmable Gate Array (FPGA) or Application Specific Integrated Circuit (ASIC). The relay may dynamically delete a supported access technology according to the service request of the UE served. As shown in FIG. 7, the flow comprises:

Step 701 is similar to step 301, thus no more details are presented here.

Step 702: according to the service request of the terminal, if the relay does not satisfy the user's QoS demand based on the current communication mode of the cell or the utilization of network resource is not optimized, the relay may change the access technology of this cell in consideration of the whole service request of the UE currently served. The relay, when changing the access technology of this cell, needs to consider that the performance of other UE served cannot be affected or the UE performance of other UE served is within a range the user can bear, or to take the service continuity of other UE served into account. If the relay cannot satisfy the user's QoS demand based on the current communication mode of the cell, the relay may also serve UE at the current location by adding another access technology. The relay sends a message to the management center module for requesting to download corresponding access technology software, and after download from the management center, the relay may re-configure the access mode of this cell or add another access mode. In the case of re-configuring the access mode of this cell, if the current cell has other UE, step 705 is performed for other UE.

The relay searches available access technology at Un (interface between the relay and network) end, and selects the access system serving the terminal, such as system A.

The communications between the relay and the resource management module is end-to-end, for example, it is conducted by any base station at the current location, and the base station transparently transmits the content of the communications therebetween.

Step 703: the relay sends a service request message to base station A, and uplink and downlink user plane information is exchanged between the relay and the base station, to establish bearer for data transmission. Base station A may allocate downlink user plane transmission resource after receiving the request message from the relay, and then send the request message to a core network to notify the core network of the allocated downlink user plane resource. After a response message of the core network is received, the response message is sent to the relay and the relay is notified of the allocated uplink user plane information.

Step 704: base station A initiates a service request and establishes bearer with the core network. Base station A may send a response message of the core network to the relay after receiving the response message, and notify the relay of the allocated uplink user plane information.

The message about the process of establishing user plane between the relay and the core network may also be transferred by the base station, and the base station does not need to analyze the specific content of the message. This embodiment only enumerates to explain the method of establishing the user plane between the relay and the core network. How to specifically establish is not the emphasis of the present invention, and it may be other specific modes but does not affect the main content of the present invention.

Step 705: for other UE served by the cell where this UE is located, the relay reconfigures the resource used by other UE to ensure that other UE continuously receives data.

Now the whole work flow in Embodiment 3 of the communication system and communication method of the present invention is completed.

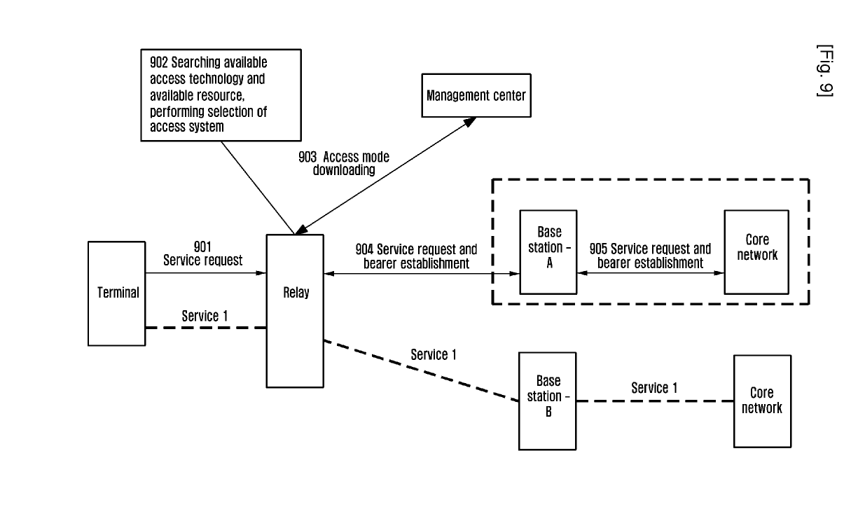

FIG. 8 is Embodiment 4 of the present invention. This embodiment is about how the base station dynamically changes the access mode it supports with no relay deployment. The base station dynamically adds the supported access mode according to the service request of the UE served, and can download the access mode required to be supported from a common management center. The access mode is carried out by different software programming and does not require the support of the hardware such as FPGA or ASIC. The base station may also dynamically delete a supported access technology according to the service demand of the UE served. The base station may also dynamically delete access technology of a certain cell according to the service demand of the UE served. As shown in FIG. 8, the flow comprises:

Step 801: the terminal has a service demand, and sends a service request message to base station A. The message comprises the service type requested by the terminal and QoS information. Before sending this message, the terminal may detect available access technology at the current location and selects the most suitable access technology at the current location.

Step 802: according to the service demand of the terminal, if base station A cannot satisfy user's QoS demand based on the existing access technology of this cell or the utilization of network resource is not optimized, base station A may change the access technology of this cell. Base station A needs to consider that the performance of other UE served cannot be affected or the performance of other UE served is within a range the UE can bear, or to consider the service continuity of other UE served. If base station A cannot satisfy user's QoS demands based on the current communication mode of this cell, base station A may also serve UE at the current location by adding another access technology. Base station A sends message to the management center module for requesting to download a corresponding access technology software and, after download from the management center, base station A can re-configure the access mode of this cell or add an access mode. In the case of re-configuring the access mode of this cell, if there are other UE in the current cell, step 803 is performed for other UE.

Step 803: for other UE served by the cell where this UE is located, base station A reconfigures the resource used by other UE to ensure that other UE continuously receive data.

Step 804: base station A initiates a service request and establishes bearer with the core network.

Now the whole work flow in Embodiment 4 of the communication system and method of the present invention is completed.

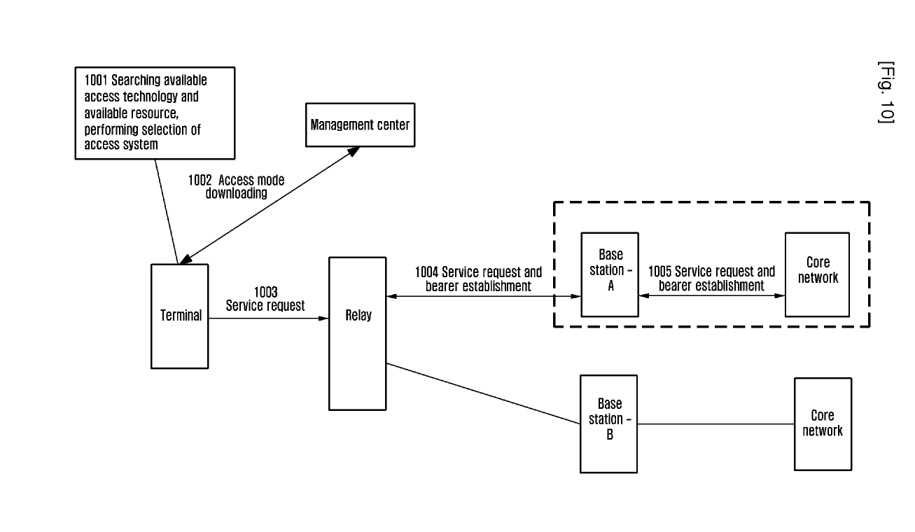

FIG. 9 is Embodiment 5 of the present invention. In this embodiment, the relay may provide service for an identical UE by different communication modes, for example, the relay select the access mode of an Un interface according to different service demands. Or the relay may dynamically change the access mode supported by the Un interface according to the requirement of the environment (for example, the type of the base station serving the relay is changed when the relay is in a mobile environment). As shown in FIG. 9, the flow comprises:

Step 901 is similar to step 301, thus no more details are presented.

Step 902, according to the service demand of the terminal, the relay searches available communication modes and available resource. There are various specific searching ways. For example, mode 1: cells of respective base stations broadcast available resource information, or QoS information that can be provided. The relay obtains available resource information by listening to the corresponding information. Mode 2: available resource information is broadcasted by a resource management module. The resource management module may obtain resource information available for cells of each base station by interacting with each base station. Mode 3: the relay is aware of available resource information of the current available access system by interacting with the resource management module, and specifically, the relay reports available RAT and/or cell information at the current location to the resource management module which returns available resource information of each access system cells. According to the resource information available for the cells of each access system, the relay decides which access system(s) are used to serve UE.

For example, one service of the current UE is sent by base station B. However, the cell of base station B cannot provide service required by the service that the UE newly requests, for example, QoS cannot be satisfied. Access technology A at the current location may satisfy service demand of UE. However, the relay currently cannot support access technology A, or the current UE does not have service 1. Only base station A can serve the relay at the current location, and the relay cannot support access technology A now (for example, the relay only support access technology B).

Step 903: the relay sends a message to the management center module for requesting to download the corresponding access technology software, and after downloading from the management center, the relay can be used to support access technology A at Un interface. The access technologies that the relay supports in Uu interface and Un interface may be different. The type of the access technology supported at Un interface may dynamically change. The relay may delete a kind of access technology according to demand or may download an access technology software from the management center according to the user's service demand. Thus the relay may simultaneously access to a plurality of access systems and provide different kinds of services for UE so as to satisfy user's QoS demand to the largest extent and ensure optimal use of network resource.

The communications between the relay and the resource management module is end-to-end, and may be conducted by any base station at the current location, wherein the base station transparently transmits the communication content therebetween.

Step 904: the relay sends a service request message to base station A, and uplink and downlink user plane information is exchanged between the relay and base station to establish bearer for data transmission. Base station A may allocate downlink user plane transmission resource after receiving the request message from the relay, and sends the request message to a core network to notify the core network of the allocated downlink user plane resource. After a response message of the core network is received, the response message is sent to the relay, and the relay is notified of the allocated uplink user plane information.

Step 905: base station A initiates a service request and establishes bearer with the core network. Base station A may send a response message of the core network to the relay after receiving the response message, and notify the relay of the allocated uplink user plane information.

The message about the process of establishing user plane between the relay and the core network may also be transferred by the base station, and the base station does not need to analyze the specific content of the message. This embodiment only enumerates to explain the method of establishing the user plane between the relay and the core network. How to specifically establish is not the emphasis of the present invention, and it may other specific modes but does not affect the main content of the present invention.

Now the whole work flow in Embodiment 5 of the communication system and communication method of the present invention is completed.

Corresponding to the above method, the present invention provides network side equipment, comprising:

a receiving module for receiving service request and data information of user equipment (UE);

a resource allocation module for selecting communications resource of two or more base stations for the UE, wherein at least two base stations having different communications modes; and

a sending module for sending data information to the UE according to the communications resource.

Furthermore, it also comprises a dynamic loading module for dynamically adding the supported access mode according to the service request of UE or environment condition, wherein the communication mode corresponding to the access mode includes but is not limited to the following one or more communication systems: GSM, WCDMA, LTE or LTE-A.

Furthermore, it also comprises a common communication module for transmitting with UE uplink and downlink common information independent from the communication mode. Common information may be transmitted by a new common channel or by add new information transmission in the existing communication mode. The resource allocation is performed in the uplink and downlink common channels through a resource allocation module.

Obviously, the network side equipment for carrying out the method may be present as different network entities in the existing network, for example, the network side equipment includes but is not limited to: RN, base station or resource management module function entity.

In this embodiment, the receiving module of the network side equipment merges data from two or more base stations having different communication modes, and/or partitions and sends the data to two or more base stations having different communication modes by the sending module. Particularly, when the network side equipment is a base station per se, the data information is interacted with another or more base stations with different communication modes.

Another embodiment of the present invention may also provide a method for cellular communications, comprising the following steps:

user equipment (UE) sending service request to network side equipment;

the UE receiving communication resource of two or more base stations that the network side equipment selects for UE, wherein at least two base stations have different communication modes;

the UE communicating with the base station according to the communication resource.

In the method set forth in the present invention, UE can receive the information of multiple equipments at network side, for example, the services provided by multiple base stations or a base station having various communication modes. In the present invention the network side equipment includes but is not limited to: RN, base station or resource management module functional entity.

In addition, when the UE judges that the communication mode of the base station and/or RN in the base station does not match its access technology, the communication mode corresponding to the access mode includes but is not limited to one or more communication systems: GSM, WCDMA, LTE or LTE-A.

In addition, uplink and downlink common channels independent from the communication modes are established between the UE and the network side equipment, and the UE and the network side equipment communicate through the uplink and downlink common channels to obtain the communication resource.

FIG. 10 is Embodiment 6 of the present invention. In this embodiment, the terminal may dynamically change the access mode it supports according to requirement of environment (for example, the access type of the relay for which service is provided in the mobile environment). As shown in FIG. 10, the flow comprises:

Step 1001, according to the service demand, the terminal searches available communication modes and available resource. There are various specific searching ways. For example, Mode 1: cells of respective base stations or the relay broadcast available resource information, or QoS information that can be provided. The terminal obtains available resource information by listening to corresponding information. Mode 2: available resource information is broadcasted by a resource management module. The resource management module may obtain resource information available for cells of each base stations or the relay by interacting with each base stations or the relay. Mode 3: the terminal is aware of available resource information of the current available access system by interacting with the resource management module, specifically, the terminal reports available RAT and/or cell information at the current location to the resource management module which returns resource information of each access system cells. According to resource information available for cells of each access system, the terminal decides which access system(s) are used to serve UE.

For example, there is access technology A at the current location that may satisfy service demand of UE. However, the terminal now cannot support access technology A. Or only relay supporting access technology A can serve the terminal at the current location, but the terminal now cannot support access technology A (for example, the terminal can only support access technology B).

Step 1002: the terminal sends a message to the management center module for requesting to download corresponding access technology software, and after downloading from the management center is completed, the terminal can be used to support access technology A. The type of access technology the terminal supports may dynamically change. The terminal may delete an access technology according to demand, or may download an access technology software according to the user's service demand. Thus the relay may simultaneously access to a plurality of access systems and provide different kinds of services for UE so as to satisfy user's QoS demand to the largest extent and ensure optimal use of network resource.

The communication between the terminal and the management centre is end-to-end, and for example, the communication may be conducted by any base station at the current location, and the base station transparently transmits the communication content therebetween.

Step 1003, the terminal sends a service request message to the relay. The relay sends a service request to base station A, and may send a response message from base station A to UE after receiving the response message, or may directly send a response message to UE.

Step 1004, the relay sends a service request message to base station A, and uplink and downlink user plane information is exchanged between the relay and base station to establish bearer for data transmission. Base station A may allocate downlink user plane transmission resource after receiving the request message from the relay, and send the request message to a core network to notify the core network of the allocated downlink user plane resource. After a response message of the core network is received, the response message is sent to the relay, and the relay is notified of allocated uplink user plane information.

Step 1005, base station A initiates a service request and establishes bearer with the core network. Base station A may send a response message of the core network to the relay after receiving the response message, and notify the relay of the allocated uplink user plane information.

The message about the process of establishing user plane between the relay and the core network may also be transferred by the base station, and the base station does not need to analyze the specific content of the message. This embodiment only enumerates to explain the method of establishing the user plane between the relay and the core network. How to specifically establish is not the emphasis of the present invention, and it may be other specific modes but does not affect the main content of the present invention.

Now the whole work flow in Embodiment 6 of the communication system and method of the present invention is completed.

FIG. 11 is Embodiment 7 of the present invention. In this embodiment, the terminal may dynamically change the access mode it supports according to requirement of environment (for example, the access type of the relay for which service is provided in the mobile environment). As shown in FIG. 11, the flow comprises:

Step 1101, according to the service demand, the terminal searches available communication modes and available resource. There are many kinds of modes for specific searching ways. For example, Mode 1: cells of respective base stations broadcast available resource information, or QoS information that can be provided. The terminal obtains available resource information by listening to corresponding information. Mode 2: available resource information is broadcasted by a resource management module. The resource management module may obtain resource information available for cells of each base station cells by interacting with each base stations. Mode 3: the terminal is aware of available resource information of the current available access system by interacting with the resource management module, and specifically, the terminal reports available RAT and/or cell information at the current location to the resource management module which returns available resource information of each access system cells. According to resource information available for cells of each access system cells, the terminal decides which access system(s) are used to serve UE.

For example, one service of the current UE is sent by base station B. However, the cell of base station B cannot provide service required by the service that UE newly requests, for example, QoS cannot be satisfied. There is access technology A at the current location that may satisfy service request of UE. However, UE now cannot support access technology A, or the UE now does not have service 1, but there is only base station A that can be used at the current location, and the UE now cannot support access technology A (for example, the UE only support access technology B).

Step 1102: the terminal sends a message to the management center module for requesting to download corresponding access technology software, and after downloading from the management center is completed, the terminal can be used to support access technology A. The type of access technology the terminal supports may dynamically change. The terminal may delete an access technology according to demand, or may download an access technology software according to the user's service demand. Thus the relay may simultaneously access to a plurality of access systems and provide different kinds of services for UE so as to satisfy user's QoS demand to the largest extent and ensure optimal use of network resource.

The communication between the relay and the management centre is end-to-end, and for example, the communication may be conducted by any base station at the current location, and the base station transparently transmits the communication content therebetween.

Step 1103, the terminal transmits a service request message to base station A. Base station A may allocate downlink user plane transmission resource after receiving the request message from the terminal, and send the request message to a core network to notify the core network of the allocated downlink user plane resource. After a response message of the core network is received, the response message is sent to the terminal, and the allocated uplink user plane information is notified to the terminal.

Step 1104, base station A initiates a service request and establishes bearer with the core network. The base station may send a response message of the core network to the terminal after receiving the response message, and notify the terminal of the allocated uplink user plane information.

Now the whole work flow in Embodiment 7 of the communication system and communication method in the present invention is completed.

Corresponding to the above method, the present invention also provides user equipment (UE), comprising:

a sending module for sending service request to network side equipment;

a receiving module for receiving communication resource of two or more base stations selected by the network side equipment, wherein at least two base stations have different communication modes;

a resource allocation module for allocating corresponding resource for service according to communication resource; and

the sending module and the receiving module communicating with network side equipment by corresponding resource.

In addition, it also comprises a dynamic loading module for dynamically adding an access mode the same as the base station or RN when judging that the communication mode of the base station and/or RN in base station does not match its access technology, wherein the communication format corresponding to the access mode includes but is not limited to the following one or more communication systems: GSM, WCDMA, LTE or LTE-A. The dynamical loading module may also dynamically delete a supported access technology.

In addition, it also comprises a common communication module for transmitting with network side equipment uplink and downlink common information independent from the communication mode, common information is transmitted by a new common channel or by adding new information transmission in the existing communication mode.

In this embodiment, the receiving module of UE is also used to merge data from two or more base stations having different communication modes, and/or to partition and send data to two or more base stations having different communication modes by the sending module.

The above mobile terminal includes but is not limited to mobile phone, personal digital assistant (PDA) or palmtop.

To support the method or equipment of the above embodiment, it requires to add in the terminal, relay and base station 1) a cognitive radio function capable of automatically perceiving available frequency spectrum resource or wireless technology accessible in the environment, for example, there is a match module in this equipment capable of knowing, by the searching and matching of the air interface, that the access mode supported by the current cell is WCDMA, LTE, LTE-A or others; 2) SDR (Software-defined Radio) function for supporting various access modes, which can dynamically support an access mode by downloading the software of access mode and operating the software; 3) re-configuration control module for re-configuring access technology or performing reconfiguration for UE; and 4) association resource management module that can comprehensively manage wireless resource and achieve resource optimization, can dynamically configure a frequency to a cell, and transfer resource between different cells so that the utilization of resource in the whole system is optimal.

The relay and base station also need the function of self-configuring and self-optimizing in the case of supporting multiple access modes. For example, the relay or base station collects the information of the user served, comprising the information of user service. If the user currently served uses more voice service, the relay or base station requests to download access mode software of WCDMA in the management center, and after the download, configures most of cells at the current location to the mode of WCDMA by operating this software. After a period of time, there are many users of data service in the network and users' requirement for the data rate is high, the relay or base station requests to download access mode software of LTE-A in the management center, and after the download, configures most of cells at the current location to the mode of LTE-A by operating this software. For another example, if a frequency band is allocated to WCDMA and another frequency band is allocated to LTE, the relay or base station may allow LTE to use part of the frequency band of WCDMA if it found that load is lighter and users are fewer in the WCDMA system while there are more users and the load is heavier in the LTE system. For another example, if the load is lighter and users are fewer in the WCDMA system while there are more users and the load is heavier in the LTE system, the relay or base station may change the parameter of switching or the parameter re-selected by cells, so that more users select the WCDMA system. Such function of self-configuring and self-optimizing requires no manual participation, and the system is re-configured by self-detection thereof, including access mode, frequency and resource used. Moreover, according to the real-time condition of the network, the network is self-optimized such that the performance of whole network is optimal.

In the network equipment, it requires to include 1) a self-configuring, self-optimizing management functional entity for optimizing resource in the heterogeneous network, that is, no manual participation is required, and the system is re-configured by self-detection thereof, including access mode, frequency and resource used; moreover, according to the real-time condition of the network, the network is self-optimized such that the performance of whole network is optimal; 2) a re-configuring functional module for supporting re-configuring function of various access modes; moreover, it can re-configure the terminal, and in the case of changing the cell access mode, the base station sends a message to UE for re-configuring the information about the resource allocated to UE to ensure that the terminal receives service continuously.

In an operating and maintaining unit, it requires to include 1) dynamic frequency spectrum resource management such that frequency spectrum can be dynamically allocated to different operators and different communication modes. For example, operator A allocates a frequency band while operator B allocates another frequency band. The operating and maintaining unit real-time manages the use of resource, real-time user and the service condition of user of the two operators. If it is found that the users of operator A are fewer and the load is lighter while the users of operator B are more and the load is heavier, part of the frequency band of operator A may be allocated to operator B for use. For another example, if a band is allocated to WCDMA and another frequency band is allocated to LTE, the relay or base station may, if it found that the load in the WCDMA system is lighter and the user is fewer while the users in the LTE system are more and the load is heavier, assign part of frequency band of WCDMA to LTE for use. 2) Association wireless resource management that can comprehensively manage the wireless resource in the heterogeneous networks to achieve optimization of resource. According to the load condition of cells, the network dynamically configures wireless parameter such as the parameter of switching or parameter re-selected by cell, to ensure that the use of resource in respective cells and respective networks is optimal to reduce interference. 3) Self-configuring self-optimizing function module, that is, no manual participation is required, and the system is re-configured by self-detection thereof, including access mode, frequency and resource used; moreover, according to the real-time condition of the network, the network is self-optimized such that the performance of whole network is optimal. The specific implementation is described hereinabove.

The mobile communication system can simultaneously serve UE by providing a plurality of base stations and/or a base station having various communication modes by means of the above scheme set forth in the present invention. In addition, regardless of the network side equipment and UE, they can dynamically load adapted access technology, so that users can access to different communication systems anytime in any place, and meanwhile the system can be dynamically and adaptively adjusted, according to the existing resource of the network, to providing service with broader bandwidth and higher rate for user. The methods or equipments set forth in the present invention only have little change to the existing equipments or methods so that it will not affect the compatibility of equipment and achieve simpleness and efficiency.

The person skilled in the art can appreciate that the whole or part of steps carried for achieving the above embodiment method can be accomplished by program instructing the relevant hardware, and the program can be stored in a computer readable memory medium, and includes one of the steps of the method embodiment or the combination thereof during implementation.

In addition, the respective functional units in the respective embodiments of the present invention can be integrated in a processing module, also can singly, physically exist, and also can be integrated in a module by two or more units. The above integrated module can be carried out not only by means of hardware but also by means of software. The integrated module can also be stored in a computer readable memory medium if it is carried out by means of software and is sold or used as an independent product.

The memory medium mentioned above may be ROM, disc or disk.

The foregoing is part of the embodiments of the present invention. It should be pointed out that on the premise of not disengaging the principle of the present invention, the person skilled in the art can also make several improvement and modification which should be deemed as the protection scope of the present invention.

1. A method for cellular communications, comprising the following steps:
network side equipment receiving service request of user equipment (UE);
network side equipment selecting communications resource of two or more base stations for the UE;
the base station communicating with the UE.

2. The method for cellular communications according to claim 1, the two or more base stations have different communication modes.

3. The method for cellular communications according to claim 2, characterized in that the communications mode includes: GSM, WCDMA, LTE or LTE-A.

4. The method for cellular communications according to claim 1, characterized in that the network side equipment comprises RN, a base station or a resource management module functional entity.

5. The method for cellular communications according to claim 4, characterized in that when the network side equipment is RN, the RN obtains available resource information according to cell broadcasting of the base station, establishes uplink and downlink user plane information with base station, establishes bearer for data transmission, and selects communication resource of two or more base stations for the UE.

6. The method for cellular communications according to claim 4, characterized in that when the network side equipment is a resource management module functional entity, the resource management module functional entity communicates with the base station to update resource state information, so as to select communications resource of two or more base stations for UE.

7. The method for cellular communications according to claim 5, characterized in further comprising: establishing end-to-end communications between RN and the resource management module functional entity to select communications resource of two or more base stations for UE.

8. The method for cellular communications according to claim 3, characterized in that the base station or RN in the base station, according to service request of the UE or environment condition, dynamically adds the supported access mode.

9. The method for cellular communications according to claim 8, characterized in that uplink and downlink common channels independent from the communications mode are established between the network side equipment and the UE, whereby the network side equipment and the UE perform resource allocation.

10. Network side equipment, comprising:
a receiving module for receiving service request and data information of user equipment (UE);
a resource allocation module for selecting communications resource of two or more base stations for the UE, wherein at least two base stations having different communications modes; and
a sending module for sending data information to the UE according to the communications resource.

11. The network side equipment according to claim 10, characterized in further comprising a dynamic loading module for dynamically adding the supported access mode according to the service request or environment condition of the UE, wherein the communication mode corresponding to the access mode includes one or more communication systems: GSM, WCDMA, LTE or LTE-A.

12. The network side equipment according to claim 11, characterized in further comprising a common communication module for transmitting with UE uplink and downlink common information independent from the communication mode.

13. The network side equipment according to claim 11, characterized in that the network side equipment comprises: RN, a base station or a resource management module functional entity.

14. The network side equipment according to claim 10, characterized in that the receiving module merges data from two or more base stations having different communication modes, and/or the sending module partitions and sends data to two or more base stations having different communication modes.

15. A method for cellular communications, comprising the following steps:
user equipment (UE) sending service request to network side equipment;
the UE receiving communications resource of two or more base stations that the network side equipment selects for the UE, wherein at least two base stations have different communications modes;
the UE communicating with the base stations according to the communications resource.

16. The method for cellular communications according to claim 15, characterized in that the network side equipment comprises RN, a base station or a resource management module functional entity.

17. The method for cellular communications according to claim 16, characterized in that when the UE judges that the communication mode of the base station and/or RN in the base station does not match its access technology, the UE dynamically adds an access mode as same as the base station or the RN, the communication mode corresponding to the access mode comprising the following one or more communication systems: GSM, WCDMA, LTE or LTE-A.

18. The method for cellular communications according to claim 16, characterized in that uplink and downlink common channels independent from the communication modes are established between the UE and the network side equipment, the UE and the network side equipment communicate through the uplink and downlink common channels to obtain the communication resource.

19. User equipment, comprising:
a sending module for sending service request to network side equipment;
a receiving module for receiving communications resource of two or more base stations selected by the network side equipment, wherein at least two base stations have different communications modes;
a resource allocation module for allocating corresponding resource for the service according to the communication resource; and
the sending module and the receiving module communicating with the network side equipment by the corresponding resource.

20. The user equipment (UE) according to claim 19, characterized in further comprising a dynamic loading module for dynamically adding an access mode as same as the base station or the RN when the UE judges that the communication mode of the base station and/or RN in the base station does not match its access technology, the communication mode corresponding to the access mode comprising the following one or more communication systems: GSM, WCDMA, LTE or LTE-A.

21. The user equipment (UE) according to claim 20, characterized in further comprising a common communication module for transmitting uplink and downlink common information independent from the communication mode with the network side equipment.

22. The user equipment (UE) according to claim 19, characterized in that the receiving module merges data from two or more base stations having different communication modes, and/or the sending module partitions and sends data to two or more base stations having different communication modes.
